(19) United States
(12) Patent Application Publication
(10) Pub. No.: US 2006/0161602 A1
(43) Pub. Date: Jul. 20, 2006

(54) Object based access application programming interface for data versioning

(76) Inventors: John William Barrs, Austin, TX (US); Michael Wayne Brown, Georgetown, TX (US); Paul Stuart Williamson, Round Rock, TX (US)

Correspondence Address: IBM CORP (YA);C/O YEE & ASSOCIATES PC, P.O. BOX 802333, DALLAS, TX, 75380, US

(21) Appl. No.: 11/037,145

(22) Filed: Jan. 18, 2005

(51) Int. Cl. G06F 17/30; G06F 17/24; G06F 9/46

(52) U.S. Cl. 707/203; 715/511; 719/328

(57) ABSTRACT

A method, apparatus, and computer instructions for managing object properties. A setter call is received from an application, wherein the setter call includes data. A determination is made as to whether the setter call is versionable. The setter call is executed if the call is a versionable call, wherein versioning data is saved in executing the setter call.

### CROSS REFERENCE TO RELATED APPLICATIONS

The present invention is related to the following patent applications: entitled “Method and Apparatus for Dimensional Data Versioning and Recovery Management”, Ser. No. ______, attorney docket no. AUS920040309US1; entitled “Method and Apparatus for Data Versioning and Recovery Using Delta Content Save and Restore Management”, Ser. No. ______, attorney docket no. AUS920040638US1; entitled “Platform Infrastructure to Provide an Operating System Based Application Programming Interface Undo Service”, Ser. No. _____, attorney docket no. AUS920040639US1; entitled “Virtual Memory Management Infrastructure for Monitoring Deltas and Supporting Undo Versioning in a Paged Memory System”, Ser. No. ______, attorney docket no. AUS920040640US1; entitled “Infrastructure for Device Driver to Monitor and Trigger Versioning for Resources”, Ser. No. ______, attorney docket no. AUS920040641US1; entitled “Method and Apparatus for Managing Versioning Data in a Network Data Processing System”, Ser. No. AUS920040642US1, attorney docket no. ______; entitled “Heap Manager and Application Programming Interface Support for Managing Versions of Objects”, Ser. No. ______, attorney docket no. AUS920040643US1; and entitled “Method and Apparatus for Marking Code for Data Versioning”, Ser. No. ______, attorney docket no. AUS920040644US1 filed even date hereof, assigned to the same assignee, and incorporated herein by reference.

### BACKGROUND OF THE INVENTION

1. Technical Field

The present invention relates to an improved data processing and in particular to a method, apparatus, and computer instructions. Still more particularly, the present invention relates to a method, apparatus, and computer instructions for managing version of objects.

2. Description of Related Art

Data storage components, variables, collections, and multi-dimensional collections are used throughout all computer applications. During the execution of an application, the contents of these types of data storage elements will change or evolve. These changes occur due to modifications or updates to the data. These changes may be made by user input or through programmatic means. As the program logic of an application progresses, situations often arise in which the program state and the content of the data storage elements need to be reset to a prior state. This state may be an arbitrary state selected by the user or programmatically by an application. Mechanisms for incrementally saving and resetting data to a prior known state are present in many applications.

Currently available mechanisms are found in applications, such as word processors, for resetting or rolling back to a previous state. A word processor may allow a user to undo changes to a document, such as deletions, insertions, or formatting changes. A significant problem with existing mechanisms is that they are prone to inefficiencies and require explicit management by the application programmer or end user. Therefore, it would be advantageous to have an improved method, apparatus, and computer instructions for data versioning and recovery management.

### SUMMARY OF THE INVENTION

The present invention provides a method, apparatus, and computer instructions for managing object properties. A setter call is received from an application, wherein the setter call includes data. A determination is made as to whether the setter call is versionable. The setter call is executed is the call is a versionable call, wherein versioning data is saved in executing the setter call.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a block diagram of a JVM in accordance with a preferred embodiment of the present invention;

FIG. 4 is a diagram illustrating components used in data versioning and recovery in accordance with a preferred embodiment of the present invention;

FIG. 5 is a diagram illustrating components used in providing data versioning and recovery management in accordance with a preferred embodiment of the present invention;

FIG. 6 is a diagram illustrating a delta object linked list in accordance with a preferred embodiment of the present invention;

FIG. 7 is a diagram of a delta object linked list in accordance with a preferred embodiment of the present invention;

FIG. 8 is a diagram illustrating marked code in accordance with a preferred embodiment of the present invention;

FIG. 9 is an example of marked code in accordance with a preferred embodiment of the present invention;

FIG. 10 is a diagram illustrating a class that implements versioning in accordance with a preferred embodiment of the present invention;

FIG. 11 is a diagram illustrating a getter and setter in accordance with a preferred embodiment of the present invention;

FIG. 12 is a diagram illustrating grouping of objects for versioning in accordance with a preferred embodiment of the present invention;

FIG. 13 is a table identifying versioning information created through setter calls in accordance with a preferred embodiment of the present invention;

FIG. 14 is a flowchart of a process for allocating objects in accordance with a preferred embodiment of the present invention;

FIG. 15 is a flowchart of a process for storing delta data in accordance with a preferred embodiment of the present invention;

FIG. 16 is a flowchart of a process for returning an object to an earlier state in accordance with a preferred embodiment of the present invention;

FIG. 17 is a flowchart of a process for restoring an object to an earlier state in accordance with a preferred embodiment of the present invention;

FIG. 18 is a flowchart of a process for marking code for versioning in accordance with a preferred embodiment of the present invention;

FIG. 19 is a flowchart of a process for tracking changes in data in accordance with a preferred embodiment of the present invention;

FIG. 20 is a flowchart of a process for processing a getter call in accordance with a preferred embodiment of the present invention; and

FIG. 21 is a flowchart of a process for processing a setter call in accordance with a preferred embodiment of the present invention.

### DETAILED DESCRIPTION OF THE PREFERRED EMBODIMENT

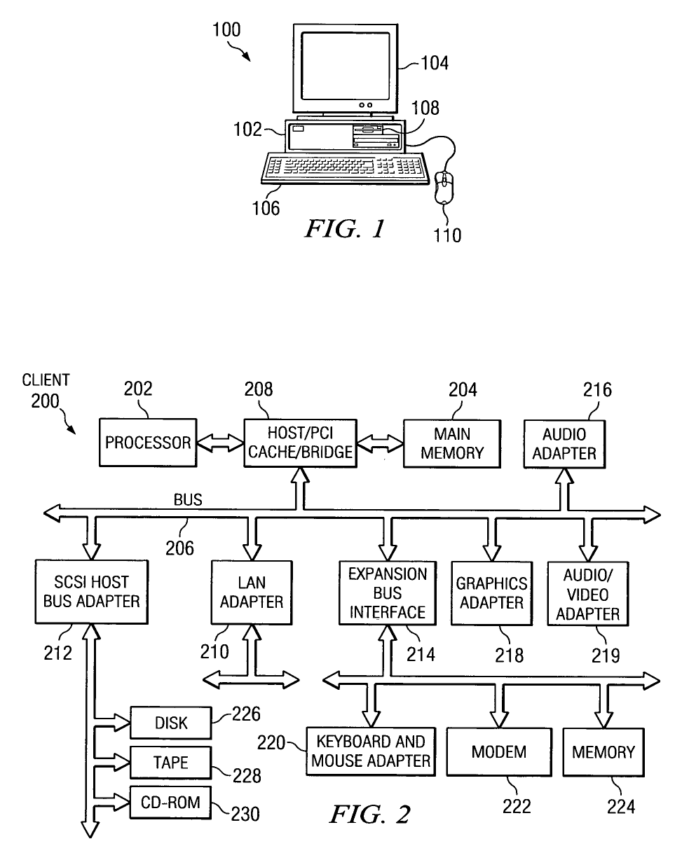

With reference now to the figures and in particular with reference to FIG. 1, a pictorial representation of a data processing system in which the present invention may be implemented is depicted in accordance with a preferred embodiment of the present invention. Computer 100 is depicted which includes system unit 102, video display terminal 104, keyboard 106, storage device 108, which may include floppy drives and other types of permanent and removable storage media, and mouse 110. Additional input devices may be included with personal computer 100, such as, for example, a joystick, touch pad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

Referring to FIG. 2, a block diagram of a data processing system in which the present invention may be implemented. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bridge 210 is connected to system bus 206 and provides an interface to I/O bus 212. Memory controller/cache 208 and I/O bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to other data processing systems may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware in FIG. 2 may vary. For example, other peripheral devices, such as optical disk drives and the like, also may be used in addition to or in place of the hardware depicted. The depicted example is not meant to imply architectural limitations with respect to the present invention.

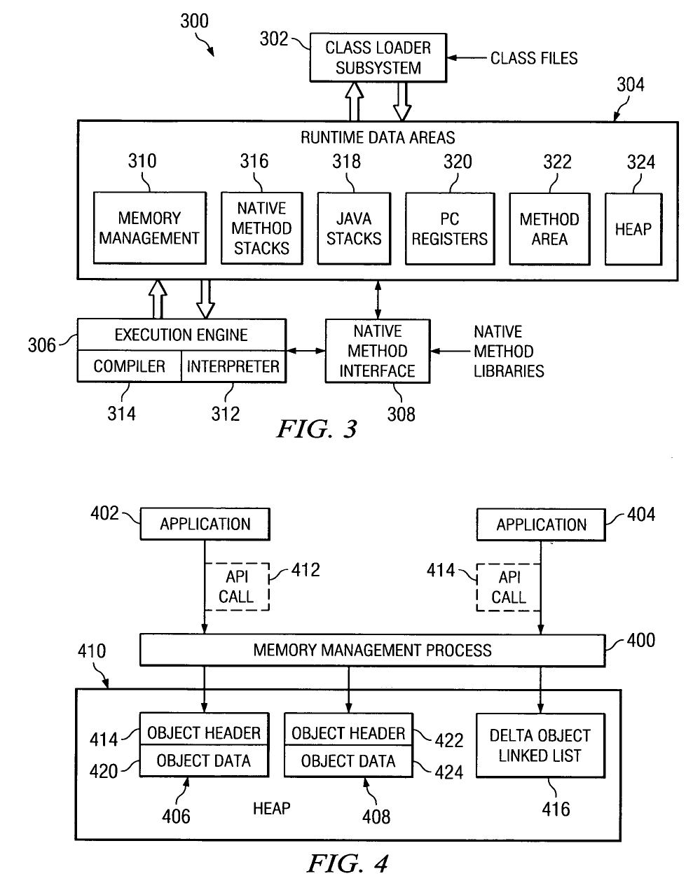

With reference now to FIG. 3, a block diagram of a JVM is depicted in accordance with a preferred embodiment of the present invention. JVM 300 includes class loader subsystem 302, which is a mechanism for loading types, such as classes and interfaces, given fully qualified names. JVM 300 also contains runtime data areas 304, execution engine 306, native method interface 308, and memory management 310. Execution engine 306 is a mechanism for executing instructions contained in the methods of classes loaded by class loader subsystem 302. Execution engine 306 may be, for example, Java interpreter 312 or just-in-time compiler 314. Native method interface 308 allows access to resources in the underlying operating system. Native method interface 308 may be, for example, the Java Native Interface (JNI).

Runtime data areas 304 contain native method stacks 316, Java stacks 318, PC registers 320, method area 322, and heap 324. These different data areas represent the organization of memory needed by JVM 300 to execute a program.

Java stacks 318 are used to store the state of Java method invocations. When a new thread is launched, the JVM creates a new Java stack for the thread. The JVM performs only two operations directly on Java stacks: it pushes and pops frames. A thread's Java stack stores the state of Java method invocations for the thread. The state of a Java method invocation includes its local variables, the parameters with which it was invoked, its return value, if any, and intermediate calculations. Java stacks are composed of stack frames. A stack frame contains the state of a single Java method invocation. When a thread invokes a method, the JVM pushes a new frame onto the Java stack of the thread. When the method completes, the JVM pops the frame for that method and discards it. The JVM does not have any registers for holding intermediate values; any Java instruction that requires or produces an intermediate value uses the stack for holding the intermediate values. In this manner, the Java instruction set is well defined for a variety of platform architectures.

Program counter (PC) registers 320 are used to indicate the next instruction to be executed. Each instantiated thread gets its own PC register and Java stack. If the thread is executing a JVM method, the value of the PC register indicates the next instruction to execute. If the thread is executing a native method, then the contents of the PC register are undefined. Native method stacks 316 stores the state of invocations of native methods. The state of native method invocations is stored in an implementation-dependent way in native method stacks, registers, or other implementation-dependent memory areas. In some JVM implementations, native method stacks 316 and Java stacks 318 are combined.

Method area 322 contains class data while heap 324 contains all instantiated objects. A heap is an area of memory reserved for data that is created at runtime. The constant pool is located in method area 322 in these examples. The JVM specification strictly defines data types and operations. Most JVMs choose to have one method area and one heap, each of which is shared by all threads running inside the JVM, such as JVM 300. When JVM 300 loads a class file, it parses information about a type from the binary data contained in the class file. JVM 300 places this type of information into the method area. Each time a class instance or array is created, the memory for the new object is allocated from heap 324. JVM 300 includes an instruction that allocates memory space within the memory for heap 324 but includes no instruction for freeing that space within the memory. Memory management 310 in the depicted example manages memory space within the memory allocated to heap 324. Memory management 310 may include a garbage collector, which automatically reclaims memory used by objects that are no longer referenced. Additionally, a garbage collector also may move objects to reduce heap fragmentation.

The present invention provides a memory management subsystem to provide for data versioning and recovery management for objects in a heap. The mechanism of the present invention saves modifications or deltas in data when objects in memory are changed. A delta in data is the difference between the data in its prior version and its current version. The different deltas may be used to restore objects to a prior state. These deltas also are referred to as delta data. In these illustrative examples, the memory management subsystem may include, for example, memory management 310 and heap 324 in FIG. 3.

The mechanism of the present invention modifies this heap to include objects for restoring delta data. In these examples, delta data represents change values or data for a particular memory object. This delta data is associated with an index. This index may take various forms, such as a number or a timestamp. In particular, these changes are stored in a data structure, for example, a linked list in a heap. The mechanism of the present invention modifies the memory management system to automatically generate this linked list in the heap of a JVM without requiring any special requests from applications or the user. Alternatively, the objects may be allocated in the heap to include the delta data.

Turning now to FIG. 4, a diagram illustrating components used in data versioning and recovery is depicted in accordance with a preferred embodiment of the present invention. Memory management process 400 receives requests from applications, such as application 402 and application 404 to allocate objects, such as objects 406 and 408. Memory management process 400 may be implemented in a memory management component, such as memory management 310 in JVM 300 in FIG. 3.

In these examples, the requests from application 402 and application 404 take the form of application programming interface (API) call 412 and API call 414. An API is a language and message format used by an application program to communicate with the operating system. APIs are implemented by writing function calls in the program, which provide the linkage to the required subroutine for execution. If these API call include an argument or parameter indicating that delta data should be stored for restoring prior versions of an object, objects 406 and 408 are allocated in a manner to allow for versioning of the objects to occur. In other words, changes in data in these objects are stored in a manner to allow the objects to be restored to a prior version.

In these illustrative examples, this delta data is maintained using delta object linked list 416, which is a data structure located within heap 410. This list is allocated by memory management process 400. This particular data structure contains a linked list of entries that identify delta data for various objects, such as object 406 and object 408.

In this example, object 406 includes object header 418 and object data 420. Object 408 includes object header 422 and object data 424. Object data 420 and object data 424 contain the data for the object in its current state. Object header 414 includes a pointer or offset to delta object linked list 416. In a similar fashion, object header 422 also includes a pointer or offset in the delta object linked list 416.

In allocating object 406 and 408, memory management process 400 also includes an indicator or tag with object headers 418 and 422. As depicted, object header 418 contains tag 426, and object header 422 contains tag 428. These indicators or tags are used to identify objects 406 and 408 as objects for which delta data will be stored to allow restoring these objects to a prior state.

When application 402 changes an object, such as object 406, memory management process 400 creates an entry within delta object linked list 410 to store the delta data. Specifically, any changed values in object 406 are stored within delta object linked list 410 in association with the identification of object 406 and an index, such as a numerical value or a timestamp.

This change in data may be stored every time an object is changed. Alternatively, the changes may be stored only when an application changes the data through an API call that includes an additional parameter or argument that indicates that the change is to occur. An example of an API call is set_version (object reference, object version). The object reference is the identification of the object, and the object version provides an identifier. Alternatively, the object version may be excluded from the call. In this case, memory management process 400 may generate a version identifier to return to the application making the call.

In this manner, all changes to object 406 are stored within delta object linked list 410. Thus, object 406 may be returned to any prior state desired using this data structure.

If a request is received by memory management process 400 to restore one of the objects in the heap to a prior state, the process identifies the object and an index to identify the state that is desired. An example of an API call is restore_version (object reference, object version). The object reference is a pointer to the object that is to be restored. The object version is an index used to identify the version of the object that is to be restored.

This index may be, for example, a numerical value or a timestamp. If, for example, object 406 is identified in the request, the object header is used to find delta object linked list 410. The index in the request is used to identify the desired state for object 406. Based on the particular entry identified in linked list 410, the linked list may be traversed to make the appropriate changes to object 406 to return that object to its original state.

In these depicted examples, all of the delta data for all objects is stored within delta object linked list 410. The entries that apply to a particular object may be identified through an object identifier that is found within each entry of delta object linked list 410.

In other illustrative examples, a separate linked list data structure may be used for each object. In this case, the object header provides an offset to the particular linked list data structure for that object.

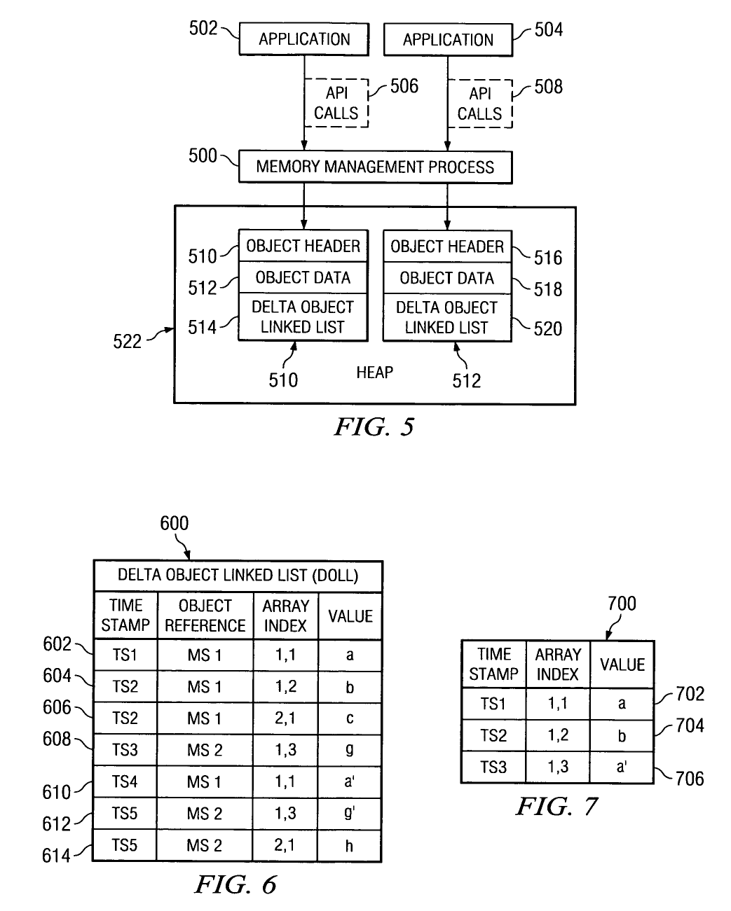

Turning next to FIG. 5, a diagram illustrating components used in providing data versioning and recovery management is depicted in accordance with a preferred embodiment of the present invention. In this example, the versioning data, also referred to as delta data, is stored within the objects.

In this illustrative example, memory management process 500 receives requests from application 502 and application 504 in the form of API calls 506 and 508 to create objects 510 and 512 for use by the applications. In this example, object 510 is created for use by application 502, and object 512 is created for use by application 504. Memory management process 500 may be implemented within memory management 310. In these examples, objects 510 and 512 contain delta data that allows these objects to be restored to a prior version or state.

Objects 510 and 512 are located in heap 514. Object 510 includes object header 516, object data 518, and delta object linked list 520. Object header 516 includes an offset to point to the beginning of delta object linked list 520 in this illustrative example. Object data 518 contains the current data for object 510. Delta object linked list 520 contains entries that identify all of the delta data for object 510. In a similar fashion, object header 522 provides an offset to the beginning of delta object linked list 524. Object data 526 contains the current data for object 512. Delta object linked list 524 contains all the delta data for changes made to object data 526. These types of objects are created when a call to allocate an object includes an additional parameter or argument that indicates that the object should be restorable to a prior state. If this additional argument or parameter is missing, the object s allocated normally.

In this illustrative example, memory management process 500 automatically increases the size of object 510 in response to a request to allocate object 510 in which the request includes an indication that that object 510 is to store data needed to restore object 510 to a prior version or state. This increased size includes space needed to store the delta data.

In addition to allocating these objects in response to a specific call requesting data versioning for the objects, this type of allocation for objects 510 and 512 may be performed automatically without requiring an application or a user to request the additional memory to store delta data. Additionally, memory management process 500 may allocate more space for object 510 and object 512 as the object data and the delta data increase for these objects.

In this particular illustrative embodiment, these objects may be moved and copied such that the delta data automatically is moved or copied with the objects. In this manner, an object may be saved and reloaded at a later time with its delta data intact. In this fashion, an object may be restored to a prior state at any time without having to locate or save data objects from the heap and restore those objects separately.

Turning now to FIG. 6, a diagram illustrating a delta object linked list is depicted in accordance with a preferred embodiment of the present invention. In the depicted example, delta object linked list 600 is an example of delta object linked list 416 as created by memory management process 400 in FIG. 4.

In these illustrative examples, delta object linked list 600 contains entries 602, 604, 606, 608, 610, 612, and 614. As shown, each of these entries contains a time stamp, an object reference, an array index, and a value. The time stamp indicates when the entry was made. The object reference is the pointer to the object for the entry. The array index identifies the location in which data has changed, and the value indicates the change in the data at that location.

In this illustrative example, the prior state is identified through a timestamp. If the memory management subsystem receives a request identifying a particular timestamp and object, the object may be returned to that state. Entry 614 is the most recent entry, while entry 602 is the oldest entry. Entries 602, 604, 606, and 610 are entries for one object, MS 1. Entries 608, 612, and 614 are entries for another object, MS 2. The mechanism of the present invention traverses the linked list from the most current entry to the entry identified by the timestamp. Entries for objects other than the selected object are ignored.

This type of traversal and restoration of data is provided as one manner in which an object may be restored to a prior state. Of course, any process used to return an object to a prior state using delta data may be employed in these illustrative examples.

The delta in data may be identified or calculated in a number of different ways. In these examples, the delta data may be calculated using an exclusive OR (XOR). In other words, the value of prior data may be XOR'd with the value of the current data to identify the change in the current data as compared to the prior data. The result of this function is considered the delta in the data in this example. With this delta the current data may be restored to the value of the current data. The data may be, for example, the values for data in all of the heaps managed by a memory management system. The delta in the data also may be calculated using Moving Picture Experts Group processes, such as MPEG 2. With these processes every delta is similar to a video frame with respect to normal use in processing video data. Instead, the deltas are for one or more memory segments. As with a video, in which not every pixel necessarily changes from frame to frame, not all of the data elements within a memory segment may change from one delta to another delta. Compression algorithms, similar to MPEG2, can be employed which minimize the amount of memory required to store the necessary information, or delta, to restore the memory segments to prior values.

Turning next to FIG. 7, a diagram of a delta object linked list is depicted in accordance with a preferred embodiment of the present invention. Delta object linked list 700 is an example a list that is found in an object. In particular, delta object link list may be implemented as delta object linked list 520 in object 510 in FIG. 5.

As shown, delta object linked list 700 includes entries 702, 704, and 706. Each entry includes a time stamp, an array index, and a value. An object reference is not included in this list as with delta object linked list 600 in FIG. 6 because this list is contained within the object for which changes in data, delta data, is stored.

Although FIGS. 6 and 7 specific types of changes in data in which an array is used to identify where changes in data has occurred, any type of system may be used to identify changes in data.

Additionally, the mechanism of the present invention allows for portions of code to be marked in which objects on the marked portions are tracked for changes. This mechanism is implemented in a memory management process, such as memory management process 500 in FIG. 5.

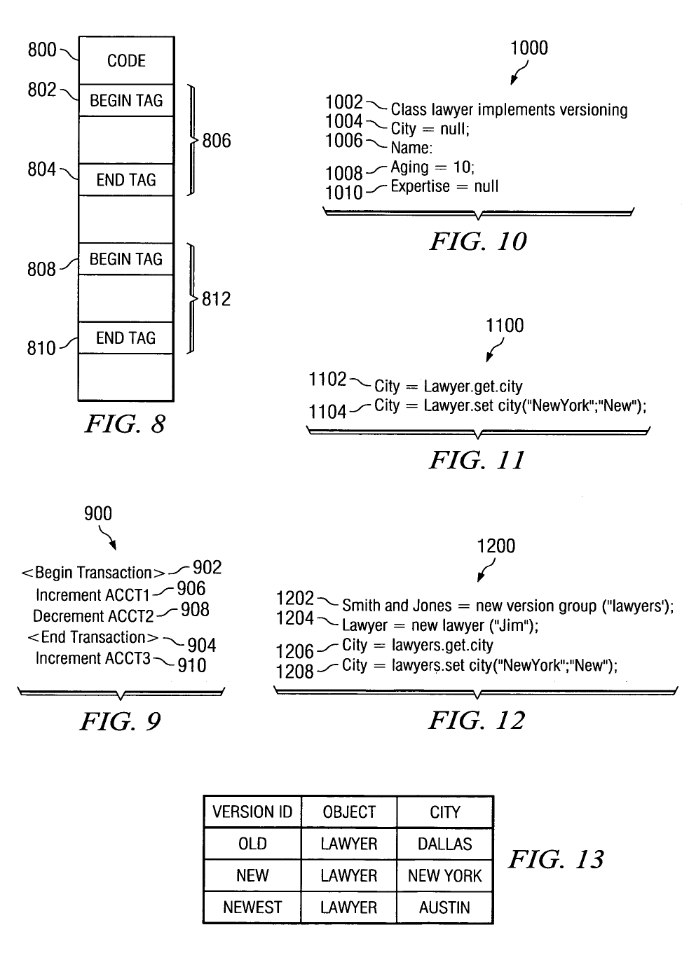

In FIG. 8, a diagram illustrating marked code is depicted in accordance with a preferred embodiment of the present invention. Code 800 is marked using begin tag 802 and end tag 804 to create marked portion 806. Additionally, begin tag 808 and end tag 810 define marked portion 812.

Any alterations or changes to objects in marked portion 806 and marked portion 812 are tracked in the manner described above. This type of tracking does not require calls to be made by the application to identify particular objects.

With reference to FIG. 9, an example of marked code is depicted in accordance with a preferred embodiment of the present invention. Code 900 is an example of marked portion of code, such as marked portion 806 in FIG. 8. Line 902 is an example of a begin tag, while line 904 is an example of an end tag. Line 906 and line 908 contain instructions that alter objects.

When line 902 is encountered during the execution of code 900, any changes to objects are tracked. Execution of line 906 results in the changes to object ACCT1 being tracked. In other words, the change is stored in a data structure such as delta object linked list 700 in FIG. 7. In this manner, this object may be restored to a prior version or state. Execution of line 908 results in a similar storing of data for object ACCT2. When line 904 is encountered, tracking changes to objects no longer occurs when execution of line 910 occurs incrementing the object ACCT3.

The tags illustrated in FIGS. 8 and 9 may be placed in to the code using different mechanisms. For example, a programmer may manually insert these tags through a user interface. Alternatively, the user interface may allow a user to select a portion of a code, such as a class or set of classes. In this example, the user enters the name of the class and the memory management process locates and inserts tags around the class.

Further, the present invention also includes a mechanism for object based access application programming interface. The mechanism adds an ability to access data elements in a class. In these examples, a specific instance of a class is referred to as an object. A version of getter and setter calls are provided in which versioning may occur through these calls. Getters and setters are calls in Java that provide direct access to properties in a class. A getter is used to read a value for a particular property, while a setter is used to write a value for a property. The mechanism of the present invention extends these calls to provide for versioning.

The versioning version of these functions is initiated when an overload occurs. As described above, an overload is present when an additional parameter or argument is present in the setter or getter call. For example, if a setter or getter includes a version identifier as an additional parameter, the version of the function that provides for versioning of data is used. Although, the versioning function is initiated in these examples though the use of an additional parameter, versioning may be initiated in other ways. For example, the versioning function may be initiated if the object in which data is changed is a versionable object, such as those shown in FIGS. 4 and 5.

Turning next to FIG. 10, a diagram illustrating a class that implements versioning is depicted in accordance with a preferred embodiment of the present invention. In this example, class 1000 is a lawyer class that implements versioning as defined in line 1002. The property “city” is initially set to null in line 1004. The name is initially null as shown in line 1006. Next, line 1008 shows an aging parameter set equal to 10. In this example, this aging parameter is used to determine the number of versions of data that may be saved for an instance of class 1000. In line 1010, the property “expertise” is initially set equal to null.

Class 1000 may be allocated in the manner illustrated in FIG. 5. In particular class 1000 may be allocated in the same way as object 510 in FIG. 5 to provide versioning capabilities. Turning now to FIG. 11, a diagram illustrating a getter and setter is depicted in accordance with a preferred embodiment of the present invention. In line 1100, a getter is illustrated in which a version of data may be requested. This getter requests a property called “city” for the object “lawyer”. This type of getter request for a version of the property called city occurs when an additional parameter “old” is included in the getter statement. In this example, the parameter is a version ID.

In line 1102, a setter is illustrated in which versioning is initiated for the object. In this example, the property “city” is set to the value “New York” by this setter for the object “lawyer”. The additional parameter “new” is used to initiate the versioning function for this setter.

In this manner, the mechanism of the present invention provides for versioning in getter and setter calls. A call that includes a parameter or argument that indicates versioning is present may be implemented using the marking process described above. In this case, tags or statements are inserted around the code for a class for which versioning is to occur. With this type of getter and setter, changes to data for a class may be detected and retrieved.

The mechanism of the present invention allows for grouping objects in handling versioning information for the objects. In this manner, a call may be applied to an entire group of objects, rather than a single group of objects. Turning to FIG. 12, a diagram illustrating grouping of objects for versioning is depicted in accordance with a preferred embodiment of the present invention. Line 1200 defines a group of objects. In this example, the group is called ” Smith and Jones” and contains objects in the class “lawyers”.

A new instance of an object in this group is created by line 1202. The property for all of the objects in the group are obtained using the statement in line 1204. This same property may be set for all of the objects in line 1206. In this manner, setter and getter functions may be applied to a group of objects with versioning. Further, this grouping of objects allows for an entire set of objects to be restored to a prior version.

In FIG. 13, a table identifying versioning information created through setter calls is depicted in accordance with a preferred embodiment of the present invention. Table 1300 contains three entries for a property called “city”. This property is a property present for an object “lawyer”, which is defined using a class, such as class 1000 in FIG. 10.

In entry 1302, the property “city” is “Dallas” and is associated with the version “old”. In entry 1304, the property “city” is “New York” and is associated with the version “new”. Entry 1304 represents data created for the setter statement in line 1102 in FIG. 11. In entry 1306, the property “city” is “Austin” and is associated with the version “newest”.

All of this versioning information is stored in association with the object “lawyer” in a data structure, such as delta object linked list 514 in FIG. 5. With this historical data, getter calls may be used to obtain prior versions of the property “city”.

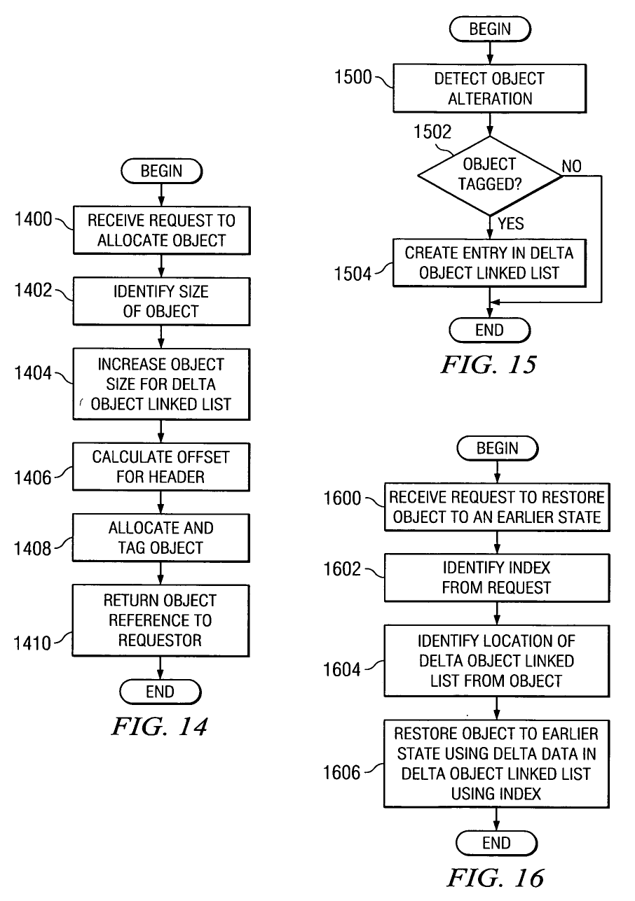

Turning now to FIG. 14, a flowchart of a process for allocating objects is depicted in accordance with a preferred embodiment of the present invention. The process illustrated in FIG. 14 may be implemented in a memory management process, such as memory management process 400 in FIG. 4.

The process begins by receiving a request to allocate an object (step 1400). In these examples, the request is received from an application, such as application 402 in FIG. 4, in the form of an API call to the JVM. In response, the size of the object is identified (step 1402). Several options exist as to where, in memory, to place the delta linked list. The consideration of which option to choose is based upon tradeoffs in performance and or memory usage. In a preferred, performance optimized embodiment, the delta object linked list is co-resident in memory with the data element for which it contains delta information. In this case, at object creation, memory is allocated sufficient to contain both the data element and an estimated size for the delta object linked list. In these examples, the estimated size being calculated primarily by the number of deltas desired to be retained. The object size for the object is increased to include the delta object linked list (step 1404).

Next, an offset is calculated and stored in the object header (step 1406). This offset is used by the memory management subsystem to point to the delta object linked list. The object is then allocated and tagged (step 1408). The object is tagged by including a tag or indicator within the object. This tag or indicator is used to identify the object as one in which delta data is stored for versioning. An object reference is then returned to the requester (step 1410). This object reference is by the requester to write or read the object.

At this point, the requestor may access the allocated object. In these illustrative examples, step 1404 may be an optional step depending on the particular implementation. In the instance in which the delta object linked list is allocated as a separate data structure from the object, this step may be skipped.

Turning now to FIG. 15, a flowchart of a process for storing delta data is depicted in accordance with a preferred embodiment of the present invention. The process illustrated in FIG. 15 may be implemented in a memory management process, such as memory management process 400 in FIG. 4.

The process begins by detecting an alteration of the data in the object (step 1500). This step may occur in different ways; for example, when the memory management process receives a request to change data in an object. When that change is processed, a determination is made as to whether the object is tagged (step 1502). The tag is used to indicate whether the object is set up such that changes in data can be stored for the object. If the object is tagged, an entry is created in the delta object linked list (step 1504) with the process terminating thereafter. Otherwise, the process terminates without storing the delta data. The linked list in step 1504 may be a combined linked list for all objects being managed. Alternatively, the linked list may be one that was created within the object when the object was allocated or as a separate linked list associated with the object.

Turning now to FIG. 16, a flowchart of a process for returning an object to an earlier state is depicted in accordance with a preferred embodiment of the present invention. In this illustrative example, the process in FIG. 16 may be implemented in a memory management process, such as memory management process 400 in FIG. 4 or memory management process 500 in FIG. 5.

The process begins by receiving a request to restore an object to an earlier state (step 1600). This request may be received from an application or a user input. Additionally, the request may be received from another process, such as an operating system or JVM process requiring the object to be returned to some other state. An index and an object identifier are identified from the request (step 1602). The location of the delta object linked list is identified from the object (step 1604). In step 1604, the location of the delta object linked list is identified using the offset from the object header. Thereafter, the object is restored to the earlier state using the delta data in the delta object linked list using the index (step 1606) with the process terminating thereafter.

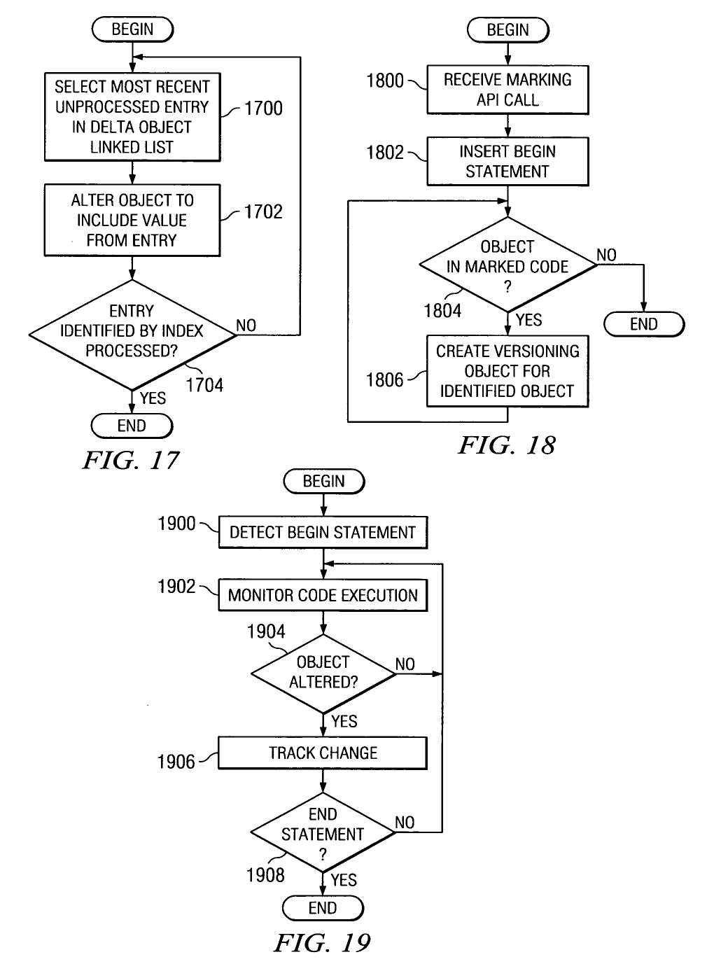

Turning now to FIG. 17, a flowchart of a process for restoring an object to an earlier state is depicted in accordance with a preferred embodiment of the present invention. The process illustrated in FIG. 17 is a more detailed description of step 1606 in FIG. 16.

The process begins by selecting a most recent unprocessed entry in the delta object linked list (step 1700). The object is then altered to include the value from the entry (step 1702). Next, a determination is made as to whether an entry identified by the index has been processed (step 1704). This step determines whether the particular index, such as a timestamp for the object, has been processed. If this entry has been processed, the object has then been returned to the desired state with the process terminating thereafter.

Otherwise, the process returns to step 1700 to select the next most recent unprocessed entry in the delta object linked list. In the instance in which the linked list includes entries for other object, a determination may be included to determine whether the object identifier is for the object that is being restored.

Turning now to FIG. 18, a flowchart of a process for marking code for versioning is depicted in accordance with a preferred embodiment of the present invention. The process illustrated in FIG. 18 may be implemented in a memory management process, such as memory management process 500 in FIG. 5.

The process begins by receiving a marking API call (step 1800). This call may be, for example, an API call that includes the name of a class as a parameter. Begin and end statements are inserted in to the code (step 1802). Next, a determination is made as to whether an unprocessed object is present in the marked code (step 1804). If an unprocessed object is present, the object is processed by creating a versioning object for the identified object (step 1806). Step 1806 allows for delta data to be stored during execution of the code. Thereafter, the process returns to step 1804 to determine whether additional unprocessed objects are present. The process terminates when all of the objects in the marked code have been processed.

With reference to FIG. 19, a flowchart of a process for tracking changes in data is depicted in accordance with a preferred embodiment of the present invention. The process illustrated in FIG. 19 may be implemented in a memory management process such as memory management process 500 in FIG. 5.

The process begins by detecting a begin statement (step 1900). Code execution is then monitored (step 1902). A determination is made as to whether an object has been altered (step 1904). If the object is altered, the change is tracked (step 1906). Next, a determination is then made as to whether an end statement has been encountered (step 1908). If an end statement has been encountered, the process is then terminated.

Turning back to step 1904, if a determination is made that no object has been altered, the process returns back to monitor code execution step 1902. The process also returns to step 1902 if an end statement is not found.

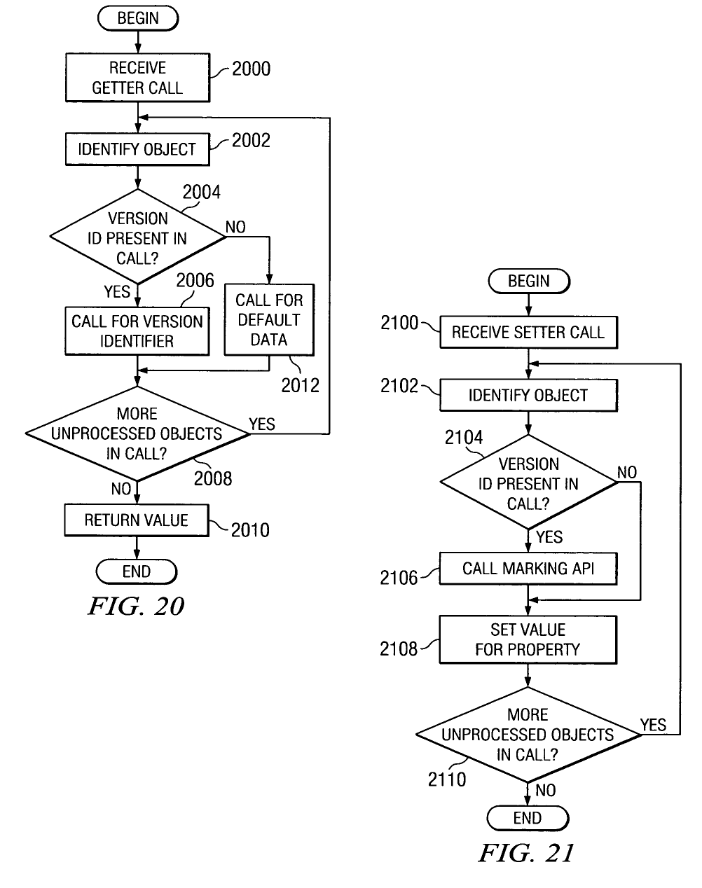

Turning to FIG. 20, a flowchart of a process for processing a getter call is depicted in accordance with a preferred embodiment of the present invention. The process illustrated in FIG. 20 may be implemented in a Java virtual machine such as Java virtual machine 300 in FIG. 3.

The process begins by receiving a getter call (step 2000). The process then identifies the object (step 2002. The object is identified in the call. Further, this object may actually be a group or set of objects. A determination is made as to whether a versioning ID is present in a call (step 2004). The presence of a version ID is considered an additional argument or parameter used to initiate the versioning feature of this call.

If a version ID is present in the call, a call is made for data using the version identifier (step 2006). Step 2006 is employed to retrieve data for a particular version as identified by the version identifier. Next, a determination is made as to whether unprocessed objects are present in the call (step 2008). Step 2008 is used to determine whether the call is for a group of objects rather than a single object. If unprocessed objects are not present in the call, the value for each object is returned (step 2010) with the process terminating thereafter.

Turning back to step 2004, if a version ID is not present in the call, the process then calls for default data (step 2012) with the process returning to step 2008. This default data is the value normally returned for the property when versioning is not present or supported. With reference again to step 2008, if more unprocessed objects are present in the call, the process returns to step 2002 to identify another object for processing.

Turning to FIG. 21, a flowchart of a process for processing a setter call is depicted in accordance with a preferred embodiment of the present invention. The process illustrated in FIG. 21 may be implemented in a Java virtual machine such as Java virtual machine 300 in FIG. 3.

The process begins by receiving a setter call (step 2100). The process then identifies the object (step 2102. The object is identified in the call. Further, this object actually may be a group or set of objects. A determination is made as to whether a versioning ID is present in a call (step 2104). The presence of a version ID is considered an additional argument or parameter used to initiate the versioning feature of this call.

If a version ID in the call is present, a marking application programming interface is called (step 2106). Step 2106 is employed to mark the object for tracking. This process is described in more detail in FIG. 18 above. Next, a value is set for the property identified in the setter call (step 2108). Afterwards, a determination is made as to whether more unprocessed objects are present in the call (step 2110). Step 2110 is used to determine whether the call is for a group of objects rather than a single object. If unprocessed objects are not present in the call, the process terminates.

Turning back to step 2104, if a version ID is not present in the call, the process proceeds directly to step 2108 as described above. In step 2110, if additional unprocessed objects are present, the process returns to step 2102.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing object properties, the method comprising:
receiving a setter call from an application, wherein the setter call includes data;
determining whether the setter call is versionable; and
executing the setter call, wherein versioning data is saved in executing the setter call.

2. The method of claim 1, wherein the setter call is versionable if at least one of a parameter is present in the setter call and the object is a versionable object.

3. The method of claim 1, wherein the data is identified by a first marking statement in the code and a second marking statement in the code, wherein a portion of code between the first marking statement and the second marking statement form a marked section of code encompassing the object, and wherein a change made in data in an object caused by execution of the marked portion of code is tracked such that the object may be restored to a prior state.

4. The method of claim 2, wherein the parameter selected from one of the versioning identifier or an indicator indicating versioning for the object.

5. The method of claim 1, wherein the data is a group of objects, wherein the group of objects is marked for versioning such that versioning data is saved for the group of objects.

6. The method of claim 1, further comprising:
receiving a getter call for data for an object;
determining whether the getter call is versionable; and
responsive to the getter call being versionable, retrieving a version of the data for the object.

7. The method of claim 6, wherein the data is for a property of the object.

8. The method of claim 6, wherein the getter call is versionable if an additional parameter is present in the getter call.

9. A data processing system for managing object properties, the data processing system comprising:
receiving means for receiving a setter call from an application, wherein the setter call includes data;
determining means for determining whether the setter call is versionable; and
executing means for executing the setter call, wherein versioning data is saved in executing the setter call.

10. The data processing system of claim 9, wherein the setter call is versionable if at least one of a parameter is present in the setter call and the object is a versionable object.

11. The data processing system of claim 9, wherein the data is identified by a first marking statement in the code and a second marking statement in the code, wherein a portion of code between the first marking statement and the second marking statement form a marked section of code encompassing the object, and wherein a change made in data in an object caused by execution of the marked portion of code is tracked such that the object may be restored to a prior state.

12. The data processing system of claim 10, wherein the parameter selected from one of the versioning identifier or an indicator indicating versioning for the object.

13. A computer program product in a computer readable medium for managing object properties, the computer program product comprising:
first instructions for receiving a setter call from an application, wherein the setter call includes data;
second instructions for determining whether the setter call is versionable; and
third instructions for executing the setter call, wherein versioning data is saved in executing the setter call.

14. The computer program product of claim 13, wherein the setter call is versionable if at least one of a parameter is present in the setter call and the object is a versionable object.

15. The computer program product of claim 13, wherein the data is identified by a first marking statement in the code and a second marking statement in the code, wherein a portion of code between the first marking statement and the second marking statement form a marked section of code encompassing the object, wherein a change made in data in an object caused by execution of the marked portion of code is tracked such that the object may be restored to a prior state.

16. The computer program product of claim 14, wherein the parameter selected from one of the versioning identifier or an indicator indicating versioning for the object.

17. The computer program product of claim 13, wherein the data is a group of objects, wherein the group of objects is marked for versioning such that versioning data is saved for the group of objects.

18. The computer program product of claim 13, further comprising:
fourth instructions for receiving a getter call for data for an object;
fifth instructions for determining whether the getter call is versionable; and
sixth instructions, responsive to the getter call being versionable, for retrieving a version of the data for the object.

19. The computer program product of claim 18, wherein the data is for a property of the object.

20. The computer program product of claim 18, wherein the getter call is versionable if an additional parameter is present in the getter call.
